(19) United States
(12) Patent Application Publication
(10) Pub. No.: US 2026/0175687 A1
(43) Pub. Date: Jun. 25, 2026

(54) SYSTEMS AND METHODS FOR GENERATING SEE-THROUGH IMAGES

(71) Applicant: Toyota Motor Engineering & Manufacturing North America, Inc., Plano, TX (US)

(72) Inventors: Xiaofei Cao, Mountain View, CA (US); Yongkang Liu, Mountain View, CA (US); Emrah A. Sisbot, Mountain View, CA (US); Lu Xu, Mountain View, CA (US); Kentaro Oguchi, Mountain View, CA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/987,900

(22) Filed: Dec. 19, 2024

(51) Int. Cl. B60K 35/23; B60W 30/09; G06T 5/70; G06T 11/00; G06V 10/82; G06V 20/58

(52) U.S. Cl. CPC B60K 35/23; B60W 30/09; G06T 5/70; G06T 11/00; G06V 10/82; G06V 20/58; G06T 2207/10028; G06T 2207/30261; G06T 2207/30264

(57) ABSTRACT

Embodiments of systems and methods for generating see-through images include a vision sensor configured to generate an image of an environmental scene surrounding a vehicle, and one or more processors operable to generate, using a pre-trained neural network, a depth map of the environmental scene based on the image, determine whether the environmental scene includes a blocking object by comparing the depth map with historical depth information of the environmental scene, in response to determining that the environmental scene includes the blocking object, update, using the pre-trained neural network, the depth map by replacing depth information of the blocking object with the historical depth information of the environmental scene at an area of the blocking object, and project the updated depth map into a see-through image of the environmental scene.

### TECHNICAL FIELD

The present specification generally relates to vehicle assistance systems and, more specifically, to vehicle parking assistance systems for generating see-through images and videos.

### BACKGROUND

Drivers often rely on various environmental elements, such as structural elements, signs, and informational elements, in making vehicle operation decisions. However, blocking views by blocking objects may cause unawareness of some of the environmental elements and further hinder the drivers from making desirable decisions in vehicle operation, such as during a parking process. Accordingly, there exists a need for vehicle assistance systems that generate see-through images and videos to supplement the blocked environmental elements to allow a driver to make desirable operations and reduce the risk of collision.

### SUMMARY

In one embodiment, a system for generating see-through images includes a vision sensor configured to generate an image of an environmental scene surrounding a vehicle, and one or more processors operable to generate, using a pre-trained neural network, a depth map of the environmental scene based on the image, determine whether the environmental scene includes a blocking object by comparing the depth map with historical depth information of the environmental scene, in response to determining that the environmental scene includes the blocking object, update, using the pre-trained neural network, the depth map by replacing depth information of the blocking object with the historical depth information of the environmental scene at an area of the blocking object, and project the updated depth map into a see-through image of the environmental scene.

In another embodiment, a method for generating see-through images includes generating, using a pre-trained neural network, a depth map of an environmental scene surrounding a vehicle based on an image of the environmental scene generated by a vision sensor, determining whether the environmental scene includes a blocking object by comparing the depth map with historical depth information of the environmental scene, in response to determining that the environmental scene includes the blocking object, updating, using the pre-trained neural network, the depth map by replacing depth information of the blocking object with the historical depth information of the environmental scene at an area of the blocking object, and generating a see-through image of the environmental scene based on the updated depth map.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example system for generating see-through images of the present disclosure, according to one or more embodiments shown and described herein;

FIG. 2 is a schematic showing the various example components of the system for generating see-through images of the present disclosure, according to one or more embodiments shown and described herein;

FIG. 3A schematically depicts an example image of an environmental scene including a blocking object of the present disclosure, according to one or more embodiments shown and described herein;

FIG. 3B schematically depicts an example depth map generated based on the image of the environmental scene of the present disclosure, according to one or more embodiments shown and described herein;

FIG. 3C schematically depicts an example updated depth map of the present disclosure, according to one or more embodiments shown and described herein;

FIG. 3D schematically depicts an example image of a see-through image of the environmental scene of the present disclosure, according to one or more embodiments shown and described herein;

FIG. 4A schematically depicts an example image of an environmental scene including a blocking object captured using a wide-angle lens of the present disclosure, according to one or more embodiments shown and described herein;

FIG. 4B schematically depicts an example depth map generated based on the wide-angle image of the environmental scene of the present disclosure, according to one or more embodiments shown and described herein;

FIG. 4C schematically depicts an example updated depth map of the wide-angle image of the present disclosure, according to one or more embodiments shown and described herein;

FIG. 4D schematically depicts an example image of a see-through wide-angle image of the environmental scene of the present disclosure, according to one or more embodiments shown and described herein;

FIG. 4E schematically depicts an example flattened see-through image of the environmental scene of the present disclosure, according to one or more embodiments shown and described herein;

FIG. 5 schematically depicts an example system for generating see-through images including a vision sensor and a reference vision sensor of the present disclosure, according to one or more embodiments shown and described herein; and

FIG. 6 depicts a flowchart of illustrative steps for generating see-through images of the present disclosure, according to one or more embodiments shown and described herein.

### DETAILED DESCRIPTION

Embodiments of systems and methods disclosed herein include a vehicle, a vision sensor, and one or more processors. The vision sensor is configured to image an environmental scene around the vehicle. The processors are configured to generate a depth map of the environmental scene based on the image generated by the vision sensor. The processors are further configured to determine a blocking object, either attached to the vehicle or in a static position in the environmental scene, by comparing the depth map with historical depth information of the environmental scene. The processors are configured to use a pre-trained neural network to update the depth map by replacing the depth information of the blocking object with the historical depth information of the environmental scene at an area of the blocking object. The processors are configured to project the updated depth map into a see-through image of the environmental scene. With the see-through image of the environmental scene, the system can provide information such as objects and/or structures blocked by the blocking object to a driver.

Drivers and users rely on various environmental elements (like structural features, signs, and other informational markers) for desirable and effective vehicle operation. When these elements are obscured by temporary objects or attachments to the vehicle, drivers may miss useful cues, leading to suboptimal decisions or increasing undesirable risks. This is especially problematic in situations like parking or maneuvering in tight spaces where visibility is limited. The disclosed vehicle assistance system that generates see-through images and/or videos offers a solution by virtually “revealing” blocked elements. For example, the disclosed systems and methods can provide enhanced decision-making support, reducing or eliminating missed cues. By displaying hidden environmental elements (e.g., directional signs, boundaries, height clearance markers), the disclosed systems and methods provide information aiding drivers to make more desirable and accurate decision-making, especially in complex environments like parking lots or urban streets. Static see-through overlays can highlight useful but maybe missed elements, such as entry and exit points, speed limits, limited access parking, or restricted access areas, and thus help drivers make desired routing decisions in areas with obstructed views and reduce drivers needing to mentally reconstruct hidden elements, but relying on visual assistance systems to show useful environmental data in real-time, reducing cognitive load and the potential for errors.

For the purposes of the present disclosure, the term “a” or “an” entity refers to one or more of that entity. As such, the terms “a” or “an”, “one or more” and “at least one” can be used interchangeably herein. The monocular depth estimation (MDE) refers to a computer vision task regarding predicting the depth information of a scene (e.g., the environment surrounding a vehicle of interest) from one or more images, especially regarding estimating distances of objects in the scene in the one or more images from the viewpoint of the corresponding imaging devices, such as cameras. For example, a MDE algorithm described herein may be a process in computer vision and deep learning where depth information is estimated from one image captured by a single camera. In some embodiments, the MDE algorithm may conduct depth estimation based on multi-view geometry of rectified stereo-or multi-camera images. The MDE algorithms described herein may include machine-learning functions to predict depth from the images. The MDE algorithms may include depth and pose networks, where the depth network predicts depth maps of the scene, and the pose network estimates the camera's motion between successive frames. Accordingly, by reconstructing the 3D structure of the scene and the attached objects from images, the MDE-based techniques described herein can create adapted vehicle geometry and enhance the understanding of the vehicle's surrounding environment for obstacle avoidance, scene reconstruction, and object recognition.

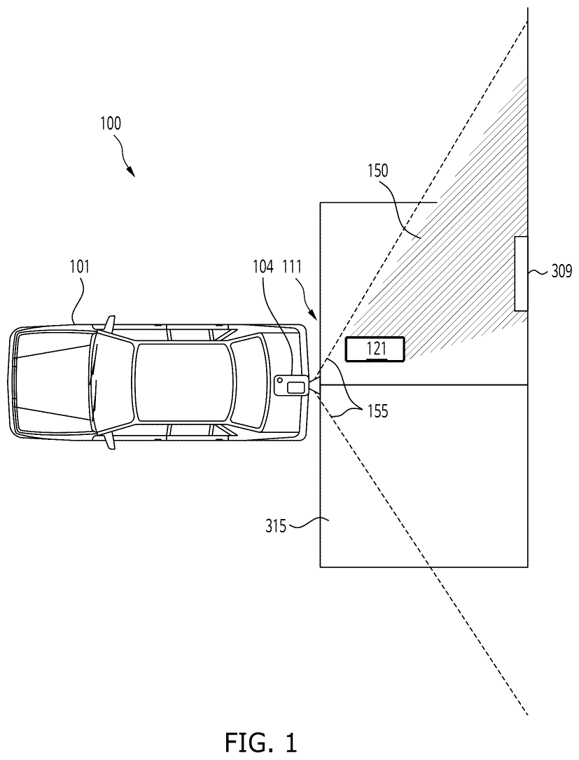

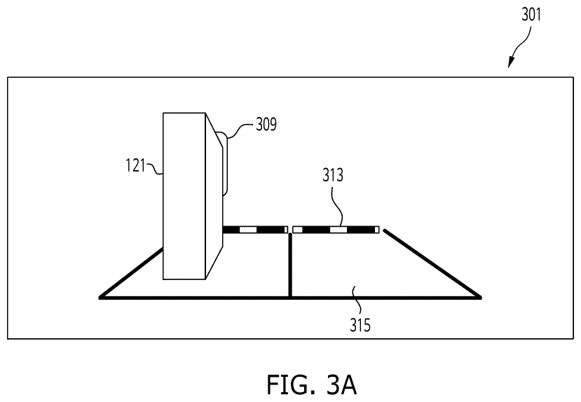

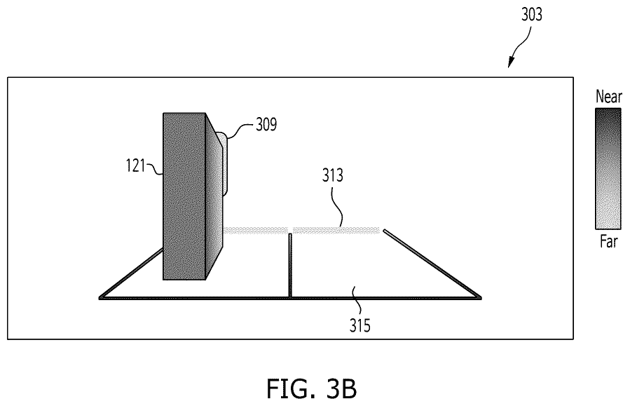

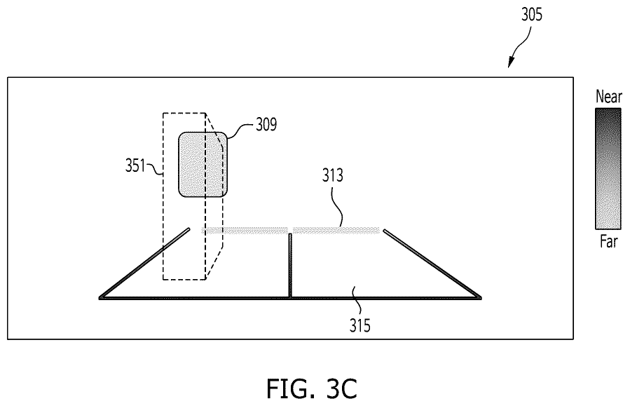

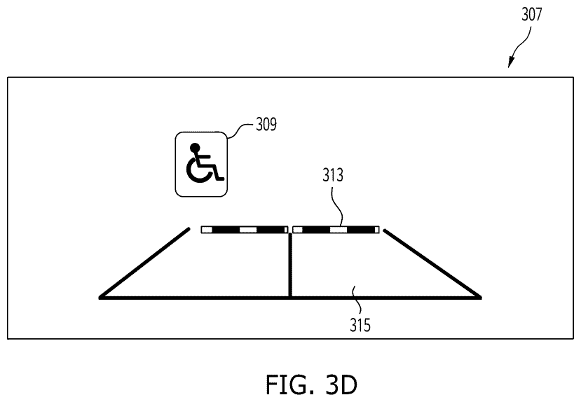

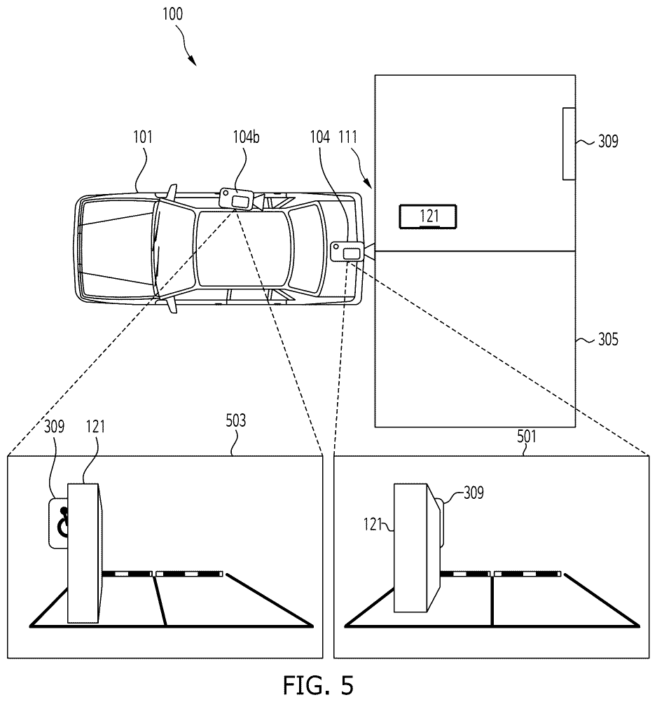

Referring now to figures, FIG. 1 depicts a see-through imaging system 100 for vehicle operation assistance. The see-through imaging system 100 may include a vision sensor 104 and a reference vision sensor 104b (as in FIG. 5) configured to image an environmental scene 111 surrounding a vehicle 101 in real time. The vision sensor 104 and the reference vision sensor 104b may be attached to the vehicle 101. The vision sensor 104 may be operably generating an image 301 (e.g., as illustrated in FIG. 3A) of the environmental scene 111 around the vehicle 101. The environmental scene 111 may include, without limitation, a blocking object 121, a parking space 315, and a signage 309. The see-through imaging system 100 may perform depth analyze, such as MDE, to generate a depth map 303 (e.g., as illustrated in FIG. 3B) of the environmental scene 111 based on the image 301, where the pixel values of the depth map 303 may be proportional to the distance between the vision sensor 104 or the reference vision sensor 104b and the objects in the image 301. The see-through imaging system 100 may determine, based on the depth map 303, the existence of the blocking object 121 in the environmental scene 111 and generate an updated depth map 305 (as illustrated in FIG. 3C) by replacing depth information of the blocking object 121 with the historical depth information of the environmental scene 111 at an area 351 (e.g., as in FIG. 3C) of the blocking object 121. The see-through imaging system 100 may then project the updated depth map 305 into a see-through image 307 (as illustrated in FIG. 3D) of the environmental scene 111.

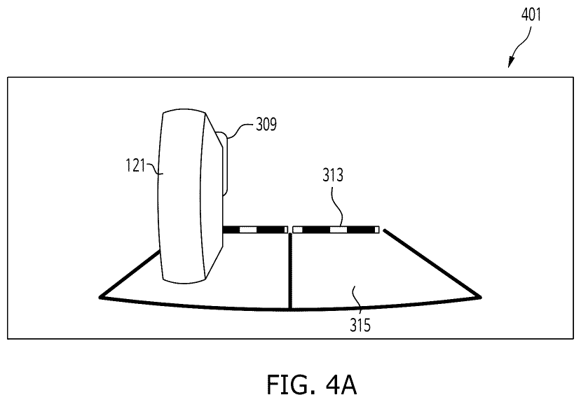

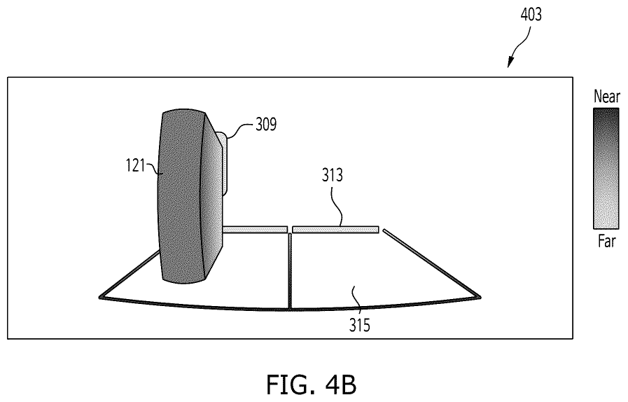

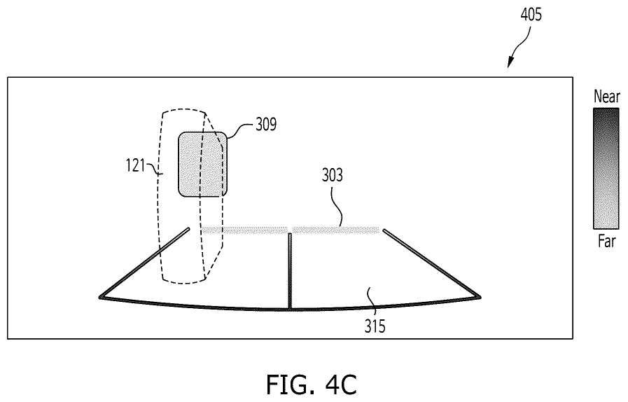

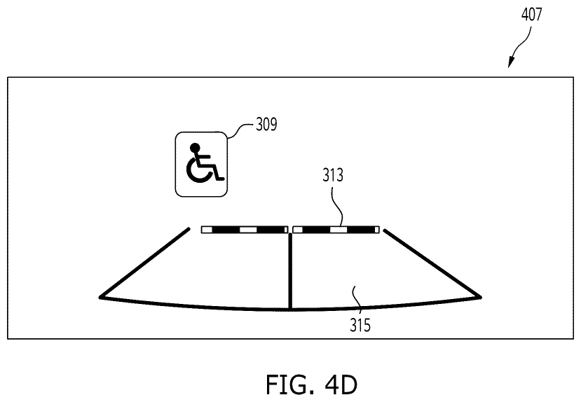

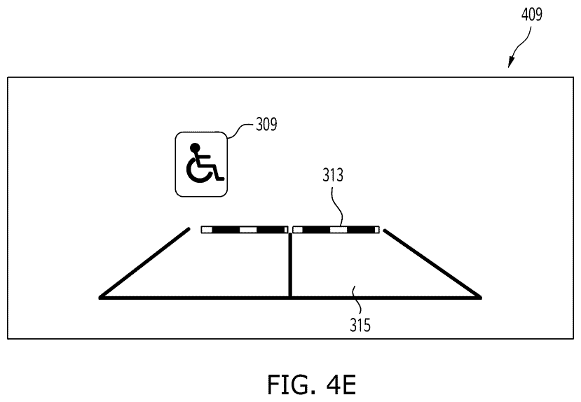

As mentioned above, the see-through imaging system 100 may include a vision sensor 104. In some embodiments, the see-through imaging system 100 may include the reference vision sensor 104b (e.g., as in FIG. 5). The vision sensor 104 and the reference vision sensor 104b may be mounted to the exterior of the vehicle 101 at the front of the vehicle 101, at the rear of the vehicle 101, on the side of the vehicle 101, on top of the vehicle 101, and/or at any other location on the vehicle 101. For example, the vision sensor 104 and the reference vision sensor 104b can be mounted to the rear of the vehicle 101 and/or one or more side view mirrors of the vehicle 101 and can have a field of view 155 to capture images and/or videos of various objects in the environmental scene 111, such as the parking space 315, the blocking object 121, and the signage 309. In some embodiments, the reference vision sensor 104b may not be mounted on the vehicle 101 but at a place capable of capturing the environmental scene 111. For example, the reference vision sensor 104b may be a security camera of a parking lot. The vision sensor 104 and the reference vision sensor 104b may be, without limitation, a monochromatic vision sensor, a monocular vision sensor, a red-green-blue (RGB) vision sensor, a red-green-blue-depth (RGB-D) vision sensor, a light detection and ranging (LiDAR) sensor, a stereo vision sensor, and/or a time-of-flight vision sensor. In some embodiments, the vision sensor 104 and the reference vision sensor 104b may include a rectilinear lens, a wide-angle lens, or a fisheye lens. The wide-angle lens or fisheye lanes may cause the vision sensor 104 or the reference vision sensor 104b to generate images that lack a straight line of perspective but instead include distortion in the image (e.g., distorted image 401 as in FIG. 4A). The vision sensor 104 and the reference vision sensor 104b may be configured to capture image 301 of the environmental scene 111. The image 301 may be, without limitation, monocular images, RGB images, or RGB-D images.

In embodiments, the environmental scene 111 may include the blocking object 121. The blocking object 121 may partially or fully block the view of the vision sensor 104 such that the objects in a blocked-view area 150 are not included in the image 301. In some embodiments, the blocking object 121 may be a temporary object presented in the environmental scene 111 and cause a narrowed view when the vehicle 101 is present in the environmental scene 111 having the temporary object. In some embodiments, the blocking object 121 may be attached to the vehicle 101 and constantly narrow the view of the vision sensor 104. The attached blocking object may be, without limitation, a cargo, a trailer, a bicycle, a kayak, a canoe, a surfboard, a paddleboard, a toolbox, camping gears, a ladder, an emergency light, or any objects suitable to be attached to the vehicle. The vehicle 101 may include one or more attachment accessories, configured to moveably attach or mount the blocking object 121 to the vehicle 101. The attachment accessories may include, without limitation, a stand, a rack, a cargo carrier, a roof rack, a bed extender, a tow hook, a tow strip, a hitch receiver, a suction cup, a magnetic mount, a customized welding or fabrication, or any combination thereof. The blocking object 121 may block at least a partial view of a static feature in the environmental scene 111. The static feature may include, without limitation, a structural element, such as buildings, walls, curbs, and landscape features. In some embodiments, the static feature in the environmental scene 111 may include a sign, a marker, or an informational notice, such as the signage 309.

In embodiments, the vehicle 101 may be an automobile or any other passenger or non-passenger vehicle such as, for example, a terrestrial, aquatic, and/or airborne vehicle. The vehicle 101 may be an autonomous vehicle that navigates its environmental scene 111 with limited human input or without human input. The vehicle 101 may include actuators for driving the vehicle, such as a motor, an engine, or any other powertrain. The vehicle 101 may move or appear on various surfaces, such as, without limitation, roads, highways, streets, expressways, bridges, tunnels, parking lots, garages, off-road trails, railroads, or any surfaces where the vehicles may operate. For example, the vehicles 101 may move within a parking lot or parking place, which includes one or more parking spaces 315. The vehicle 101 may move forward or backward.

The see-through imaging system 100 may include one or more image modules, which include one or more machine-learning algorithms, such as a depth algorithm, a blocking algorithm, and a distortion algorithm. The depth algorithm may be an MDE algorithm. The see-through imaging system 100 may generate, using the depth algorithm, depth maps 303 of interested objects in image 301 captured by the vision sensor 104 and the reference vision sensor 104b. In some embodiments, the depth algorithm may conduct a depth estimation using stereo vision techniques, which may rely on two or more vision sensor 104 to calculate depth by triangulation. In some other embodiments, the depth algorithm may estimate depth using images taken by a single camera of the vision sensor 104, such as the MDE-based technologies. The one or more machine learning algorithms may include one or more neural networks and be trained based on the one or more algorithms, such as a localization algorithm, and an ego-pose algorithm, as discussed in detail further below. In some embodiments, when the vision sensor 104 includes the wide-angle lens or the fisheye lens, the image modules may include the distorting algorithm to undistort the distorted image 401 (e.g., as in FIG. 4A) before generating the depth map 403 (as in FIG. 4B), or undistort a distorted see-through image 407 (e.g., in FIG. 4D) to generate a flattened see-through image 409 (e.g., in FIG. 4E). After the performance of flattening, the distorted image 401 and/or the distorted see-through image may appear to be captured using a rectilinear lens, where straight features, such as the edges of walls of buildings or the parking space 315, appear with straight lines, as opposed to being curved.

In embodiments, the machine-learning algorithms, such as the depth algorithm, the blocking algorithm, the distortion algorithm, the localization algorithm, and the ego-pose algorithm, may use models to generate and update depth maps 303 and/or the see-through images 307, including, without limitation, Convolutional Neural Networks (CNNs) to learn hierarchical features from images for spatial information estimation and image distortion estimation, Recurrent Convolutional Neural Networks (RNNs), such as Long Short-Term Memory (LSTM) networks, to capture temporal dependencies in sequential data, Encoder-Decoder Architectures, such as U-Net, to extract features from the image 301 to generate the corresponding depth maps 303, Residual Networks (ResNets), such as ResNet-50 and ResNet-101, to address the vanishing gradient problem for improved depth estimation performance and depth map information replacement and smoothing based on neighboring depth values, and Generative Adversarial Networks (GANs) to generate realistic depth maps by learning the distribution of depth information in training data and producing high-quality depth estimations for single images.

The machine-learning algorithms may be pre-trained using sample images and depth maps. The image modules may be trained and provided with machine-learning capabilities via a neural network as described herein. By way of example, and not as a limitation, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (Sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error. In machine learning applications, new inputs may be provided (such as the generated one or more outputs) to the ANN model as training data to continue to improve accuracy and minimize error of the ANN model. The one or more ANN models may utilize one-to-one, one-to-many, many-to-one, and/or many-to-many (e.g., sequence-to-sequence) sequence modeling. The one or more ANN models may employ a combination of artificial intelligence techniques, such as, but not limited to, Deep Learning, Random Forest Classifiers, Feature extraction from audio, images, clustering algorithms, or combinations thereof. In some embodiments, a convolutional neural network (CNN) may be utilized. For example, a convolutional neural network (CNN) may be used as an ANN that, in the field of machine learning, for example, is a class of deep, feed-forward ANNs applied for audio analysis of the recordings. CNNs may be shift or space-invariant and utilize shared-weight architecture and translation. Further, each of the various modules may include a generative artificial intelligence algorithm. The generative artificial intelligence algorithm may include a general adversarial network (GAN) that has two networks, a generator model and a discriminator model. The generative artificial intelligence algorithm may also be based on variation autoencoder (VAE) or transformer-based models. For example, the depth algorithm may involve training convolutional neural networks (CNNs) on large datasets containing pairs of example images and their corresponding depth maps. The depth maps provide ground truth depth information for each pixel in the example images. The CNN may learn to map input example images to corresponding depth maps by capturing the spatial relationships between objects and their depths in the example images.

The blocking object 121 may be imaged by the vision sensor 104 and included in the environmental scene 111 around the vehicle 101 in the image 301. The image 301 may be, without limitation, monocular images, RGB images, or RGB-D images. When the see-through imaging system 100 generates a depth map 303 of the environmental scene 111 based on an image 301 generated by the vision sensor 104, the depth map 303 may include the parking space 315, the blocking object 121, and/or the signage 309. The generated see-through image 307 may exclude the blocking object 121 and further include static objects, such as the signage 309, which is blocked by the blocking object 121, at the area 351 of the blocking object 121.

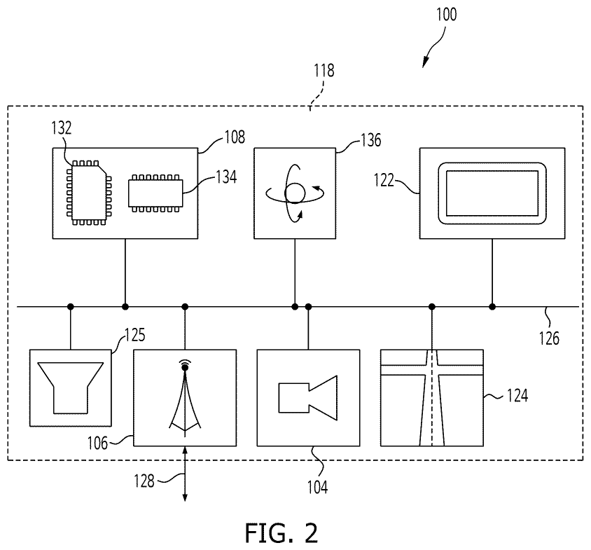

FIG. 2 is a schematic showing the various components of the see-through imaging system 100. It is to be understood that the see-through imaging system 100 is not limited to the systems and features shown in FIG. 2 and that each may include additional features and systems. The components may be associated with the vehicle 101, where the vehicle 101 may be an automobile, a boat, a plane, or any other transportation equipment. As shown, the see-through imaging system 100 may include a data unit 118 for generating, processing, and transmitting data.

The data unit 118 includes an electronic control unit (ECU) 108, a network interface hardware 106, one or more vision sensors 104, a screen 122, a navigation module 124, a speaker 125, and one or more motion sensors 136 that may be connected by a communication path 126. The network interface hardware 106 may connect the see-through imaging system 100 to external systems via an external connection 128. For example, the network interface hardware 106 may connect the see-through imaging system 100 to the vehicle 101 and/or other vehicles directly (e.g., a direct connection to another vehicle proximate to the vehicle 101) or to an external network such as a cloud server.

Still referring to FIG. 2, the ECU 108 may be any device or combination of components including one or more processors 132 and one or more non-transitory processor-readable memory modules 134. The processor 132 may be any device capable of executing a processor-readable instruction set stored in the non-transitory processor-readable memory module 134. Accordingly, the processor 132 may be an electric controller, an integrated circuit, a microchip, a computer, or any other computing device. The processor 132 is communicatively coupled to the other components of the data unit 118 by the communication path 126. Accordingly, the communication path 126 may communicatively couple any number of processors 132 with one another, and allow the components coupled to the communication path 126 to operate in a distributed computing environment. Specifically, each of the components may operate as a node that may send and/or receive data. While the embodiment depicted in FIG. 2 includes a single processor 132, other embodiments may include more than one processor.

The non-transitory processor-readable memory module 134 may be coupled to the communication path 126 and communicatively coupled to the processor 132. The non-transitory processor-readable memory module 134 may include RAM, ROM, flash memories, hard drives, or any non-transitory memory device capable of storing machine-readable instructions such that the machine-readable instructions can be accessed and executed by the processor 132. The machine-readable instruction set may include logic or algorithm(s) written in any programming language of any generation (e.g., 1GL, 2GL, 3GL, 4GL, or 5GL) such as, for example, machine language that may be directly executed by the processor 132, or assembly language, object-oriented programming (OOP), scripting languages, microcode, etc., that may be compiled or assembled into machine readable instructions and stored in the non-transitory processor-readable memory module 134. Alternatively, the machine-readable instruction set may be written in a hardware description language (HDL), such as logic implemented via either a field programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 2 includes a single non-transitory processor-readable memory module 134, other embodiments may include more than one memory module. In embodiments, the non-transitory processor-readable memory module 134 may store one or more image modules, one or more machine-learning algorithms, such as the depth algorithm, the blocking algorithm, the ego-pose algorithm, the localization algorithm, and the distortion algorithm. The non-transitory processor-readable memory module 134 may further store historical depth information of the environmental scene, sample training data, such as sample undistorted images, sample distorted images, historical images generated by the vision sensor 104 and reference vision sensor 104b, historical generated depth information, historical generated see-through images, and any historical relevant data generated through the usage of the system. The historical depth information of the environmental scene 111 may be generated based on one or more images of the environmental scene 111 without the blocking object 121.

Still referring to FIG. 2, one or more vision sensors 104 and/or reference vision sensors 104b (as in FIG. 5) are coupled to the communication path 126 and communicatively coupled to the processor 132. While the particular embodiment depicted in FIG. 2 shows an icon with one vision sensor and reference is made herein to “vision sensor” in the singular with respect to the data unit 118, it is to be understood that this is merely a representation and embodiments of the system may include one or more vision sensors 104 and/or reference vision sensors 104b having one or more of the specific characteristics described herein.

The vision sensor 104 and/or the reference vision sensors 104b in FIGS. 1 and 5 may be, without limitation, one or more of monocular cameras, RGB cameras, or RGB-D cameras. The vision sensor 104 may be, without limitation, one or more of rearview cameras, side-view cameras, front-view cameras, or top-mounted cameras. In some embodiments, the one or more vision sensors 104 may be any device having an array of sensing devices capable of detecting radiation in an ultraviolet wavelength band, a visible light wavelength band, or an infrared wavelength band. The one or more vision sensors 104 may have any resolution. In some embodiments, one or more optical components, such as a mirror, fish-eye lens, or any other type of lens may be optically coupled to the one or more vision sensors 104. In embodiments described herein, the one or more vision sensors 104 may provide image data to the ECU 108 or another component communicatively coupled to the communication path 126. The image data may include image data of the environmental scene 111 around the vehicle 101. In some embodiments, for example, in embodiments in which the vehicle 101 is an autonomous or semi-autonomous vehicle, the one or more vision sensors 104 may also provide navigation support. That is, data captured by the one or more vision sensors 104 may be used by the navigation module 124 to autonomously or semi-autonomously navigate the vehicle 101.

The one or more vision sensors 104 may operate in the visual and/or infrared spectrum to sense visual and/or infrared light. Additionally, while the particular embodiments described herein are described with respect hardware for sensing light in the visual and/or infrared spectrum, it is to be understood that other types of sensors are contemplated. For example, the systems described herein could include one or more monochromatic vision sensors, monocular vision sensors, RGB vision sensors, RGB-D vision sensors, LiDAR sensors, stereo vision sensors, time-of-flight vision sensors, radar sensors, sonar sensors, or other types of sensors and such data could be integrated into or supplement the data collection described herein to develop a fuller real-time traffic image.

In operation, the one or more vision sensors 104 capture image data and communicate the image data to the ECU 108 and/or to other systems communicatively coupled to the communication path 126. The image data may be received by the processor 132, which may process the image data using one or more image processing algorithms. The imaging processing algorithms may include, without limitation, an object recognition algorithm, such as a real-time object detection model, and a depth algorithm, such as the MDE depth algorithm. Any known or yet-to-be developed video and image processing algorithms may be applied to the image data in order to identify an item or situation. Example video and image processing algorithms include, but are not limited to, kernel-based tracking (such as, for example, mean-shift tracking) and contour processing algorithms. In general, video and image processing algorithms may detect objects and movements from sequential or individual frames of image data. One or more object recognition algorithms may be applied to the image data to extract objects and determine their relative locations to each other. Any known or yet-to-be-developed object recognition algorithms may be used to extract the objects or even optical characters and images from the image data. Example object recognition algorithms include, but are not limited to, scale-invariant feature transform (“SIFT”), speeded-up robust features (“SURF”), and edge-detection algorithms. The image processing algorithms may include machine learning functions and be trained with sample images including ground truth objects and depth information.

The network interface hardware 106 may be coupled to the communication path 126 and communicatively coupled to the ECU 108. The network interface hardware 106 may be any device capable of transmitting and/or receiving data with external vehicles or servers directly or via a network. Accordingly, network interface hardware 106 can include a communication transceiver for sending and/or receiving any wired or wireless communication. For example, the network interface hardware 106 may include an antenna, a modem, LAN port, Wi-Fi card, WiMax card, mobile communications hardware, near-field communication hardware, satellite communication hardware and/or any wired or wireless hardware for communicating with other networks and/or devices. In embodiments, network interface hardware 106 may include hardware configured to operate in accordance with the Bluetooth wireless communication protocol and may include a Bluetooth send/receive module for sending and receiving Bluetooth communications.

In embodiments, the data unit 118 may include one or more motion sensors 136 for detecting and measuring motion and changes in motion of the vehicle 101. Each of the one or more motion sensors 136 is coupled to the communication path 126 and communicatively coupled to the one or more processors 132. The motion sensors 136 may include inertial measurement units. Each of the one or more motion sensors 136 may include one or more accelerometers and one or more gyroscopes. Each of the one or more motion sensors 136 transforms the sensed physical movement of the vehicle 101 into a signal indicative of an orientation, a rotation, a velocity, or an acceleration of the vehicle 101. In some embodiments, the motion sensors 136 may include one or more steering sensors. The one or more steering sensors may include, without limitation, one or more of steering angle sensors, vehicle speed sensors, gyroscopes, inertial measurement units, or any other steering sensors operable to collect data on vehicle trajectory. For example, the steering angle sensor may measure the rotation of the steering wheels of the vehicle 101 and provide data on the angle at which the steering wheel is turned, indicating the intended direction of the vehicle. The vehicle speed sensors may monitor the speed of the vehicle wheels to provide real-time data on the vehicle's speed. The gyroscopes may detect the changes in orientation and angular velocity of the vehicle 101 by measuring the rate of rotation around different axes.

In embodiments, the data unit 118 includes a screen 122 for providing visual output such as, for example, maps, navigation, entertainment, seat arrangements, real-time images/videos of surroundings, or a combination thereof. The screen 122 may be located on the head unit of the vehicle 101 such that a driver of the vehicle 101 may see the screen 122 while seated in the driver's seat. The screen 122 is coupled to the communication path 126. Accordingly, the communication path 126 communicatively couples the screen 122 to other modules of the data unit 118. The screen 122 may include any medium capable of transmitting an optical output such as, for example, a cathode ray tube, a light emitting diode (LED) display, an organic light emitting diode (OLED) display, a liquid crystal display, a plasma display, or the like. In embodiments, the screen 122 may be a touchscreen that, in addition to visually displaying information, detects the presence and location of a tactile input upon a surface of or adjacent to the screen 122. The screen may display images captured by the one or more vision sensors 104. In some embodiments, the screen may display a depth map that is generated based on the image captured by the one or more vision sensors 104.

In embodiments, the data unit 118 may include the navigation module 124. The navigation module 124 may be configured to obtain and update positional information of the vehicle 101 and to display such information to one or more users of the vehicle 101. The navigation module 124 may be able to obtain and update positional information based on geographical coordinates (e.g., latitudes and longitudes), or via electronic navigation where the navigation module 124 electronically receives positional information through satellites. In certain embodiments, the navigation module 124 may include a GPS system.

In embodiments, the data unit 118 includes the speaker 125 for transforming data signals into mechanical vibrations, such as in order to output audible prompts or audible information to a driver of the vehicle. The speaker 125 is coupled to the communication path 126 and communicatively coupled to the one or more processors 132. The speaker 125 may output a warning sound based on distances between the vehicle 101 and external objects measured by the see-through imaging system 100.

In embodiments, the one or more processors 132 may operably control the steering and break of the vehicle 101 to enable the vehicle 101 to perform various maneuvers, such as, without limitation, accelerating or decelerating to reach a desirable velocity, stopping at desirable position, and turning at desirable angle.

Referring now to FIGS. 3A-3D, example image 301 captured by vision sensor 104 and example see-through image 307 generated by the see-through imaging system 100 are depicted. In embodiments, the vision sensor 104 of the vehicle 101 may image the environmental scene 111 surrounding the vehicle 101 to generate the image 301. As illustrated in FIGS. 3A-3D, in some embodiment, the image 301 may include a parking space 315, a blocking object 121, and a signage 309. Each parking space 315 may include, without limitation, a parking stall, markings, symbols (e.g., no parking zones, accessible parking designations, loading/unloading areas), wheel stops, signage (e.g., parking regulations, time limits, permit requirements, restrictions, safety warnings), or other structure and elements associated with the parking space 315. One or more blocking objects 121 may be present near or around the vehicle 101 and/or the parking spaces 315, such as the attachment accessories to the vehicle 101 (such as a bike attached to a rack attached to the vehicle 101), the wheel stop 313, and physical structures such as walls or barriers as part of the parking building. The blocking object 121 may be positioned close to parking spaces in a way that drivers need to be mindful of their proximity to the blocking object 121 or anything blocked by the blocking object 121, such as the signage 309, when maneuvering into or out of parking spaces.

In some embodiments, the image 301 taken by the vision sensor 104 may include the blocking object 121, the parking space 315, the wheel stop 313, blocking object 121, and the signage 309. In some embodiments, some of the objects in the environment may be blocked by the blocking object 121 and the image 301 may not include the blocked object or may partially include the blocked objects in the blocked-view area 150. For example, in FIG. 3A, only the right edge of the signage 309 is shown in the image 301.

As illustrated in FIG. 3B, the see-through imaging system 100 may generate the depth map 303 based on the image 301. For example, the system may use one or more of the depth algorithms, such as the MDE algorithms, to generate depth maps 303 from the input image 301. The see-through imaging system 100 may extract relevant features in the image 301 using machine-learning functions, such as CNNs to capture desired visual cues. The see-through imaging system 100 may then process these features using a depth prediction network that learns to map the features to depth values. The see-through imaging system 100 may estimate the distances of objects, such as the parking spaces 315, the blocking object 121, and the wheel stops 313, in the environmental scene 111 surrounding the vehicle 101 from the viewpoint of the vision sensor 104 (e.g., the rear camera) capturing the image 301. For example, as illustrated in FIG. 3B, the depth map 303 is generated based on the image 301 in FIG. 3A. The shapes, locations, and depth information of the objects, such as the blocking object 121 and the wheel stops 313, are represented in the depth map 303, with the dark monochromatic color representing near and light monochromatic color representing far to the vision sensor 104. In some embodiments, the see-through imaging system 100 may include more than one vision sensor 104, generate depth maps 303 for each images captured by different vision sensors 104, and then use the depth maps 303 to determine the blocking object 121 based on all the depth maps 303 generated by different vision sensor 104. For example, the blocking object 121 may be determined by aggregating the depth map based on the image 301 and another depth map based on the additional image (e.g., the reference image 503 as in FIG. 5).

The see-through imaging system 100 may recognize, using the blocking algorithm, the blocking object 121 based on the image 301 of FIG. 3B. In some embodiment, the see-through imaging system 100 may recognize the blocking object 121 using the one or more pre-trained real-time object detection models, as discussed further above. In some embodiments, the see-through imaging system 100 may recognize the blocking object 121 based on the depth map 303. For example, in some embodiments, the see-through imaging system 100 may identify the blocking object 121 from the image 301 based on a comparison of depths in the depth map 303 and the historical depth map of the environmental scene 111. The blocking algorithm may determine the depth pixel difference between the depth map 303 and the historical depth map. The blocking algorithm may then determine the blocking object 121 is present when difference of the depth pixel of the blocking object 121 and the depth pixel of the historical depth map in the area of the blocking object 121 is beyond a blocking depth threshold. The blocking depth threshold may be set based on the physical dimensions of the vehicle 101, the precision of depth sensing technology of the vehicle 101, and the expected range of distances between the vehicle 101 and any static objects in the environmental scene 111. The blocking depth threshold may be manually changed by the user.

In some embodiments, the see-through imaging system 100 may identify the blocking object 121 based on the relative motion of the blocking object 121 against the vehicle 101 and further determine whether the blocking object 121 is attached to the vehicle 101 or in a static position. The vision sensor 104 may continuously generate the image 301 in a sequence of time frames. The see-through imaging system 100 may generate corresponding depth maps 303 from the image 301 in the sequence of time frames. The see-through imaging system 100 may identify the blocking object 121 as attached to the vehicle 101 from the corresponding depth maps 303 representing a substantially constant depth and a substantially constant coordinate in the corresponding depth maps 303. In some embodiments, when the vision sensor 104 continuously generates image 301 in the sequence of time frames, the vehicle 101 may further using the one or more steering sensors to generate a real-time trajectory of the vehicle 101. The trajectory may represent the path or movement of the vehicle 101 over time, such as trajectory information of the vehicle's position, orientation, velocity, and acceleration. By comparing the relative motion of the blocking object 121 in the image 301 and/or the depth maps 303 against the vehicle trajectory, the see-through imaging system 100 may identify the blocking object 121 that exhibits motion patterns consistent with being attached to the vehicle 101 or in a static position near the vehicle 101.

In some embodiments, the see-through imaging system 100 may determine whether a distance between the vehicle 101 and the blocking object 121 is less than a collision threshold value. The collision depth threshold may be set based on the physical dimensions of the vehicle 101, the precision of depth sensing technology of the vehicle 101, and the expected range of distances between the vehicle 101 and the blocking object 121. The collision depth threshold may be manually changed by the user. In response to determining that the distance is less than the collision threshold value, the see-through imaging system 100 may send instruction to the vehicle 101 and/or operate the vehicle 101 to avoid a collision between the vehicle 101 and the blocking object 121. For example, the see-through imaging system 100 may instruct and/or operate the vehicle 101 to brake or change a moving path.

Referring to FIG. 3C, upon determining the blocking object 121 exist in the environmental scene, the see-through imaging system 100 may use the pre-trained neural network including the blocking algorithm to update the depth map 303 by replacing depth information of the blocking object 121 with the historical depth information of the environmental scene 111 at the area 351 of the blocking object 121. The historical depth information of the environmental scene 111 may be generated based on one or more images of the environmental scene 111 without the blocking object 121. The historical depth information of the environmental scene 111 at the area 351 of the blocking object 121 may be determined based on neighboring depth values around the area 351 of the blocking object 121. In operation, the see-through imaging system 100 may first generate an object mask including the depth pixels representing the blocking object 121. The see-through imaging system 100 may then set depth values of the object pixels, where the mask is true, to a predetermined value, such as zero or NaN, to indicate that those areas need to be inpainted. After removing the object's depth pixels, the see-through imaging system 100 may fill the missing pixels with desirable depth values that reflect the background as if the blocking object 121 does not exist. For example, the see-through imaging system 100 may compare the depth information in the depth map 303 with historical depth information of the environmental scene 111, which may be generated based on one or more images of the environmental scene 111 without the blocking object, and fill the missing pixels with the depth values in the area 351 of the blocking object 121. The see-through imaging system 100 may employ depth inpainting techniques, such as, without limitation, patch-based inpainting or deep learning-based inpainting to estimate the missing depth values. For example, the blocking algorithm may include techniques like bilinear interpolation or Navier-Stokes inpainting to fill in the missing pixels with values that match the surrounding depth values. The blocking algorithm may be trained using GANs.

In some embodiments, after the update the depth map 303 by replacing depth information of the blocking object 121 with the historical depth information of the environmental scene 111 at the area 351 of the blocking object 121, the see-through imaging system 100 may further perform refinement, such as smoothing and/or edge refinement, to the updated depth map 305. The see-through imaging system 100 may apply filters such as Gaussian smoothing or bilateral filters to smooth the updated depth map 305 and remove any sharp edges introduced by inpainting where the blocking object is removed. The see-through imaging system 100 may refine the edges around the area 351 to reduce or remove seams or undesirable transitions between the foreground and background.

Referring to FIG. 3D, after the depth map 303 is updated as in FIG. 3C, the see-through imaging system 100 may project the updated depth map 305 into the see-through image 307 of the environmental scene 111. The see-through image 307 may include the original pixels in the image 301 that is not part of the blocking object 121 and filled pixels representing objects and structures blocked by the blocking object 121. The filled pixels may include the objects and structures captured in earlier images without the blocking object 121. For example, the signage 309, which is blocked by the blocking object 121 and is captured in previous images accessed by the see-through imaging system 100, can be seen in the see-through image 307. The see-through image 307 thus allows a user to access information despite physical obstructions.

Referring now to FIGS. 4A-4E, example image 301 captured by the vision sensor 104 including the wide-angle lens and example see-through image 307 generated by the see-through imaging system 100 are depicted. In some embodiments, the vision sensor 104 may be a wide-angle camera or a fisheye camera such that the distorted image 401 may lack a straight line of perspective but instead include distortion in the image. Similar to FIGS. 3A-3D, FIGS. 4A-4D depicts that the see-through imaging system 100 may use the vision sensor 104 to image the environmental scene 111 surrounding the vehicle 101 to generate the distorted image 401, generate the depth map 403 based on the distorted image 401, use the pre-trained neural network including the blocking algorithm to update the depth map 403 by replacing depth information of the blocking object 121 with the historical depth information of the environmental scene 111 at the area 351 of the blocking object 121, and further project the updated depth map 405 into the distorted see-through image 407 of the environmental scene 111. Accordingly, the above description of embodiments in FIGS. 3A-3D can be applied to the embodiments in FIGS. 4A-4D. However, due to the wide-angle lens or fisheye lens used in the embodiments of FIGS. 4A-4E, the distorted image 401, the depth map 403, the updated depth map 405, and/or the see-through image 407 may include curved structures, such as lines of the parking space 315 and edges of the blocking object 121, where the corresponding structures in FIGS. 3A-3D are linear.

In some embodiments, as in FIGS. 4D and 4E, the see-through imaging system 100 may undistort the see-through image 407 to generate a flattened see-through image 409. The see-through imaging system 100 may use the image module that includes the distortion algorithm to undistort the image. The distortion algorithm may be associated with the vision sensor 104 including the wide-angle lens that the neural network of the distortion algorithm is trained based on sample undistorted images captured using a non-wide-angle lens and sample images captured using the wide-angle lens. The distortion algorithm may be trained based on sample undistorted images captured using a non-wide-angle lens sensor and sample images captured using the wide-angle lens and/or the fisheye lens.

In some embodiments, the wide-angle lens and/or the fisheye lens of the vision sensor 104 may capture the distorted image 401 including radial distortion or barrel distortion such that the distorted image 401 includes circular or curved lines near edges. The image module including the distortion algorithm may be pre-trained by acquiring multiple distorted images of a known pattern, such as a checkerboard pattern, and then using that pattern to estimate the distortion parameters. During the training, the vision sensor 104 may be placed at different angles and positions during the distorted image acquisition. The distorted image may include the corner points of the checkerboard in each image. The image module may then use the distortion algorithm to estimate the vision sensor's 104 intrinsic parameters, such as, without limitation, focal length, optical center, and extrinsic parameters, such as, without limitation, position and orientation of the vision sensor 104, along with the distortion coefficients, such as, without limitation, a radial distortion coefficient and a tangential distortion coefficient, by mapping the pixel coordinates in the images to the estimated real-world coordinate in the pattern. In some embodiments, the calibration of the distortion algorithm to perform the distortion function may be performed using the ego-pose algorithm and the localization algorithm. In some embodiments, the flattening may be performed on the distorted image 401 before being transferred into the depth map 403.

Referring back to FIGS. 3A-4E, in some embodiments, the various machine-learning algorithms, such as the depth algorithm, the blocking algorithm, the distortion algorithm, the epo-pose algorithm, and the localization algorithm, may be pre-trained. The see-through imaging system 100 may train the machine-learning algorithms on datasets with ground truth images and corresponding depth maps. The see-through imaging system 100 may optimize the models in the machine-learning algorithms for depth information, blocking, and distortion predictions through validation processes, such as backpropagation. The see-through imaging system 100 may further apply post-processing to refine the depth map to output the depth map as a grayscale image representing estimated object distances to the cameras taking the image. For example, the pre-training may include labeling the example images and desirable depth information, the blocking depth information, and flatten image information in the images, and using one or more neural networks to learn to predict the desirable and undesirable depth information, blocking depth information, and flatten image information from the input images based on the training data. The pre-training may further include fine-tuning, evaluation, and testing steps. The image modules of the depth algorithms may be continuously trained using the real-world collected data to adapt to changing conditions and factors and improve performance over time. The neural network may be trained based on the backpropagation using activation functions. For example, the encoder may generate encoded input data h=(Wx+b) that is transformed from the input data of one or more input channels. The encoded input data of one of the input channels may be represented as hᵢⱼ=g(Wxᵢⱼ+b) from the raw input data xᵢⱼ, which is then used to reconstruct the output \tilde{x}ᵢⱼ=f (W^{T}hᵢⱼ+b′) . The neural networks may reconstruct outputs, such as the depth information in the depth map, into x′=(W^{T}h+b′), where W is weight, b is bias, W_{T}, and b′ are transverse values of W and b and are learned through backpropagation. In this operation, the neural networks may calculate, for each input data, the distance between an input data x and a reconstructed input data x′, to yield a distance vector |x-x′|. The neural networks may minimize the loss function which is a utility function as the sum of all distance vectors. The accuracy of the predicted output may be evaluated by satisfying a preset value, such as a preset accuracy and area under the curve (AUC) value computed using an output score from the activation function (e.g. the Softmax function or the Sigmoid function). For example, the see-through imaging system 100 may assign the preset value of the AUC with a value of 0.7 to 0.8 as an acceptable simulation, 0.8 to 0.9 as an excellent simulation, or more than 0.9 as an outstanding simulation. After the training satisfies the preset value, the pre-trained or updated machine-learning algorithms may be stored in the ECU 108.

Referring to FIG. 5, example calibrations of the image modules of the see-through imaging system 100 based on ego-pose algorithm and the localization algorithm are depicted. In some embodiments, the image modules of the see-through imaging system 100 may include the ego-pose algorithm and the localization algorithm. The ego-pose algorithm may calibrate the depth value evaluation based on the position, orientation, and spatial location of the vision sensor 104 relative to a reference coordinate frame in the environmental scene 111. The localization algorithm may be used by the see-through imaging system 100 to calibrate depth values generated by the vision sensor 104 according to depth values in reference images generated by one or more reference vision sensors 104b, and positions and orientations of the reference vision sensors 104b related to the vision sensor 104.

The see-through imaging system 100 may use the ego-pose algorithm to adjust depth values based on a position and orientation of the vision sensor 104 in a reference coordinate, and fuse a sequential depth map frame based on a previous depth map frame using pose transformations in the reference coordinate. For example, in operation, the see-through imaging system 100 may provide a 3D (x, y, z) coordinates, an orientation (roll, pitch, yaw) of the vision sensor 104 in the reference coordinate frame in the environmental scene 111. The see-through imaging system 100 may adjust the estimated depth values relative to the camera's translation and rotation to evaluate the project depth points in the 3D space, and transform previous depth maps into the current depth map pose using pose transformations to fuse depth information across multiple frames. The image module may use the ego-pose algorithm to identify and segment an object in a sample depth map and provide ego-pose information about that object. As such, the depth map is transformed into a consistent world coordinate frame for imaging module training, and the depth pixels of the object corresponding to the real-world space can be identified. In some embodiments, when the vision sensor 104 information, such as altitude, focal length, and orientation relative to the scene is tuned to adjust the depth estimation model, the machine learning algorithms can be calibrated with improved depth prediction for objects at varying angles and distances. Once depth maps from multiple frames are transformed into a common reference frame using pose transformations, the depth data can be fused using weighted averaging, Kalman filtering, or other sensor fusion techniques to improve depth accuracy and fill in gaps.

In some embodiments, the image modules may include the localization algorithm. The localization algorithm may be used by the see-through imaging system 100 to calibrate depth values generated by the vision sensor 104 according to depth values in a reference image 503 generated by the reference vision sensor, and positions and orientations of the reference vision sensor 104b related to the vision sensor 104. In operation, the see-through imaging system 100 may collect the information of the positions and orientations of the vision sensor 104 (such as at the rear of the vehicle 101) and the reference vision sensor 104b (such as at a side of the vehicle 101) in a mapped environment. The positions of the vision sensor 104 and the reference vision sensor 104b may be acquired using simultaneous localization and mapping method or GPS-based positioning. The vision sensor 104 may capture an image 501 of the environmental scene 111 including the blocking object 121, the parking space 315, and partial signage 309 from a central viewpoint. The reference vision sensor 104b may capture a reference image 503 including the blocking object 121, the parking space 315, and partial signage 309 from a right viewpoint. The see-through imaging system 100 may use the depth algorithm to generate the depth map for the image 501 and the reference image 503, and associate depth maps to a global coordinate to predict the appearance of background objects and structures. The localization algorithm may mask the object segmentation based on its expected location in the depth map generated based on the image 501 compared with the depth map generated based on the reference image 503. The two depth maps derived from the image 501 captured by the visions sensor 104 and the reference image 503 captured by the reference vision sensor 104b from different viewpoints can be transformed into the same global frame and combined for a more complete representation of the scene. Consequently, when the blocking object 121 is removed, the background can be inpainted based on the depth data from a prior view of the scene in the historical data. For example, the background depth data can be drawn from the same global position where the blocking object 121 is located in the historical depth information of the environmental scene.

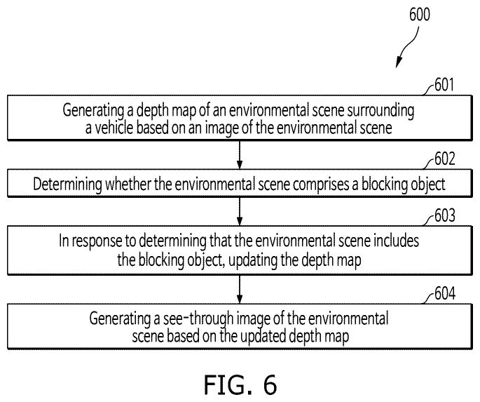

Referring to FIG. 6, a flowchart of illustrative steps for generating see-through images of the present disclosure is depicted. At block 601, the method 600 for generating see-through images includes generating, using a pre-trained neural network, a depth map 303 of an environmental scene 111 surrounding a vehicle 101 based on an image 301 of the environmental scene 111. At block 602, the method 600 for generating see-through images includes determining whether the environmental scene 111 includes a blocking object 121 by comparing the depth map 303 with historical depth information of the environmental scene 111. At block 603, the method 600 for generating see-through images includes in response to determining that the environmental scene 111 includes the blocking object 121, updating, using the pre-trained neural network, the depth map 303 by replacing the depth information of the blocking object 121 with the historical depth information of the environmental scene at an area 351 of the blocking object 121. At block 604, the method 600 for generating see-through images includes generating a see-through image 307 of the environmental scene 111 based on the updated depth map 305.

In some embodiments, the historical depth information of the environmental scene 111 at the area 351 of the blocking object 121 may be determined based on neighboring depth values around the area 351 of the blocking object 121. The historical depth information of the environmental scene may be generated based on one or more images of the environmental scene 111 without the blocking object 121. The vision sensor 104 may include a monochromatic vision sensor, a monocular vision sensor, a red-green-blue (RGB) vision sensor, a red-green-blue-depth (RGB-D) vision sensor, a light detection and ranging (LiDAR) sensor, a stereo vision sensor, a time-of-flight vision sensor, or a combination thereof.

In some embodiments, the pre-trained neural network may include an ego-pose algorithm. The method 600 may further include adjusting, using the ego-pose algorithm, depth values based on a position and orientation of the vision sensor 104 in a reference coordinate, and fusing, using the ego-pose algorithm, a sequential depth map frame based on a previous depth map frame using pose transformations in the reference coordinate.

In some embodiments, the pre-trained neural network may include localization algorithm. The method 600 may further include calibrating, using the localization algorithm, depth values generated by the vision sensor 104 according to depth values in reference images 503 generated by one or more reference vision sensors 104b, and positions and orientations of the reference vision sensors 104b related to the vision sensor 104.

In some embodiments, the vision sensor 104 may include wide-angle lens or a fisheye lens. The method 600 may further include undistorting, using the pre-trained neural network, the see-through image 407. In some embodiments, the neural network is trained based on sample undistorted images captured using a non-wide-angle lens sensor and sample images captured using the wide-angle lens.

In some embodiments, the updating the depth map 303 may further include smoothing the depth map 303 and refining edges where the blocking object 121 is removed.

In some embodiments, the method 600 may further include determining whether a distance between the vehicle 101 and the blocking object 121 is less than a threshold value, and in response to determining that the distance is less than the threshold value, operating the vehicle to avoid a collision between the vehicle and the blocking object.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

It should also be understood that, unless clearly indicated to the contrary, in any methods claimed herein that include more than one step or act, the order of the steps or acts of the method is not necessarily limited to the order in which the steps or acts of the method are recited.

It is to be understood that the embodiments are not limited in their application to the details of construction and the arrangement of components set forth in the description or illustrated in the drawings. The invention is capable of some embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

What is claimed is:

1. A system for generating see-through images comprising:
a vision sensor configured to generate an image of an environmental scene surrounding a vehicle; and
one or more processors operable to:
generate, using a pre-trained neural network, a depth map of the environmental scene based on the image;
determine whether the environmental scene comprises a blocking object by comparing the depth map with historical depth information of the environmental scene;
in response to determining that the environmental scene comprises the blocking object, update, using the pre-trained neural network, the depth map by replacing depth information of the blocking object with the historical depth information of the environmental scene at an area of the blocking object; and
project the updated depth map into a see-through image of the environmental scene.

2. The system of claim 1, wherein the historical depth information of the environmental scene at the area of the blocking object is determined based on neighboring depth values around the area of the blocking object.

3. The system of claim 1, wherein the pre-trained neural network comprises an ego-pose algorithm, and the one or more processors are operable to:
adjust, using the ego-pose algorithm, depth values based on a position and orientation of the vision sensor in a reference coordinate; and
fuse, using the ego-pose algorithm, a sequential depth map frame based on a previous depth map frame using pose transformations in the reference coordinate.

4. The system of claim 1, wherein the pre-trained neural network comprises a localization algorithm, and the one or more processors are operable to:
calibrate, using the localization algorithm, depth values generated by the vision sensor according to:
depth values in reference images generated by one or more reference vision sensors, and;
positions and orientations of the reference vision sensors related to the vision sensor.

5. The system of claim 1, wherein the vision sensor comprises a wide-angle lens, and the one or more processors are further operable to:
undistort, using the pre-trained neural network, the see-through image.

6. The system of claim 5, wherein the neural network is trained based on sample undistorted images captured using a non-wide-angle lens and sample images captured using the wide-angle lens.

7. The system of claim 1, wherein the historical depth information of the environmental scene is generated based on one or more images of the environmental scene without the blocking object.

8. The system of claim 1, wherein the updating the depth map further comprises smoothing the depth map and refining edges where the blocking object is removed.

9. The system of claim 1, wherein the vision sensor comprises a monochromatic vision sensor, a monocular vision sensor, a red-green-blue (RGB) vision sensor, a red-green-blue-depth (RGB-D) vision sensor, a light detection and ranging (LiDAR) sensor, a stereo vision sensor, a time-of-flight vision sensor, or a combination thereof.

10. The system of claim 1, wherein the one or more processors are further operable to:
determine whether a distance between the vehicle and the blocking object is less than a threshold value; and
in response to determining that the distance is less than the threshold value, operate the vehicle to avoid a collision between the vehicle and the blocking object.

11. A method for generating see-through images comprising:
generating, using a pre-trained neural network, a depth map of an environmental scene surrounding a vehicle based on an image of the environmental scene generated by a vision sensor;
determining whether the environmental scene comprises a blocking object by comparing the depth map with historical depth information of the environmental scene;
in response to determining that the environmental scene comprises the blocking object, updating, using the pre-trained neural network, the depth map by replacing depth information of the blocking object with the historical depth information of the environmental scene at an area of the blocking object; and
generating a see-through image of the environmental scene based on the updated depth map.

12. The method of claim 11, wherein the historical depth information of the environmental scene at the area of the blocking object is determined based on neighboring depth values around the area of the blocking object.

13. The method of claim 11, wherein the pre-trained neural network comprises an ego-pose algorithm, and the method further comprises:
adjusting, using the ego-pose algorithm, depth values based on a position and orientation of the vision sensor in a reference coordinate; and
fusing, using the ego-pose algorithm, a sequential depth map frame based on a previous depth map frame using pose transformations in the reference coordinate.

14. The method of claim 11, wherein the pre-trained neural network comprises a localization algorithm, and the method further comprises:
calibrating, using the localization algorithm, depth values generated by the vision sensor according to depth values in reference images generated by one or more reference vision sensors, and positions and orientations of the reference vision sensors related to the vision sensor.

15. The method of claim 11, wherein the vision sensor comprises a wide-angle lens, and the method further comprises:
undistorting, using the pre-trained neural network, the see-through image.

16. The method of claim 15, wherein the neural network is trained based on sample undistorted images captured using a non-wide-angle lens sensor and sample images captured using the wide-angle lens.

17. The method of claim 11, wherein the historical depth information of the environmental scene is generated based on one or more images of the environmental scene without the blocking object.

18. The method of claim 11, wherein the updating the depth map further comprises smoothing the depth map and refining edges where the blocking object is removed.

19. The method of claim 11, wherein the vision sensor comprises a monochromatic vision sensor, a monocular vision sensor, a red-green-blue (RGB) vision sensor, a red-green-blue-depth (RGB-D) vision sensor, a light detection and ranging (LiDAR) sensor, a stereo vision sensor, a time-of-flight vision sensor, or a combination thereof.

20. The method of claim 11, wherein the method further comprises:
determining whether a distance between the vehicle and the blocking object is less than a threshold value; and
in response to determining that the distance is less than the threshold value, operating the vehicle to avoid a collision between the vehicle and the blocking object.
